(19) United States
(12) Patent Application Publication
(10) Pub. No.: US 2026/0113749 A1
(43) Pub. Date: Apr. 23, 2026

(54) UPLINK LATENCY REDUCTION

(71) Applicant: TELEFONAKTIEBOLAGET LM ERICSSON (PUBL), Stockholm (SE)

(72) Inventors: Ali Nader, Malmö (SE); Sina Maleki, Malmö (SE); Andres Reial, Höllviken (SE); Nianshan Shi, JÄRFÄLLA (SE)

(21) Appl. No.: 19/114,234

(22) PCT Filed: Sep. 15, 2023
(86) PCT No.: PCT/IB2023/059200

§ 371 Date: Mar. 21, 2025

Related U.S. Application Data
(60) Provisional application No. 63/409,371, filed on Sep. 23, 2022.

(51) Int. Cl. H04W 72/21; H04W 52/02; H04W 76/28

(52) U.S. Cl. CPC H04W 72/21; H04W 52/0235; H04W 76/28

(57) ABSTRACT

A method performed by UE for reducing latency. The method includes receiving first configuration information for at least a first uplink (UL) resource, the first UL resource used to access a wireless network and associated with a network node operating in discontinuous transmission and reception (DTRX). The method also includes receiving second configuration information for at least a second UL resource, the second UL resource also used to access the wireless network. The method further includes accessing the wireless network using the second UL resource when the first UL resource is in an off period of the DTRX.

### TECHNICAL FIELD

Disclosed are embodiments related to methods for reducing uplink (UL) latency.

### BACKGROUND

Fifth Generation (5G) Radio Access Network (RAN) Architecture

The New Radio (NR) 5G RAN (NG-RAN) architecture is depicted and described in 3GPP Technical Specification (TS) 38.401 v17.0.0, also depicted in FIG. 1

A typical NG-RAN comprises a set of gNBs connected to a 5G core network (5GC) through the NG interface. As specified in 3GPP TS 38.300, the NG-RAN could also consist of a set of ng-eNBs. An ng-eNB may consist of a central unit (CU) (a.k.a., ng-eNB-CU) and one or more distributed units (DUs) (a.k.a., ng-eNB-DUs). An ng-eNB-CU and an ng-eNB-DU may be connected via the W1 interface. The general principle described in this section also applies to an ng-eNB and the W1 interface, unless explicitly stated otherwise.

A gNB can support Frequency Division Duplex (FDD) mode, Time Division Duplex (TDD) mode or dual mode operation. gNBs can be interconnected through the Xn interface. A gNB may consist of a CU (a.k.a., gNB-CU) and one or more DUs (a.k.a., gNB-DUs). A gNB-CU and a gNB-DU are connected via the F1 interface. One gNB-DU is connected to only one gNB-CU. NG, Xn and F1 are logical interfaces.

For NG-RAN, the NG and Xn-C interfaces for a gNB consisting of a gNB-CU and gNB-DUs terminate in the gNB-CU. For EN-DC, the S1-U and X2-C interfaces for a gNB consisting of a gNB-CU and gNB-DUs terminate in the gNB-CU. The gNB-CU and the connected gNB-DUs are only visible to other gNBs and the 5GC as gNB. The overall architecture for separation of gNB-CU-CP and gNB-CU-UP is depicted in FIG. 2

### Multiple Uplink Resources

In NR, a user equipment (UE) can be configured with multiple uplink (UL) carriers when using Carrier Aggregation (CA) or Dual Connectivity (DC). Additionally, NR also supports Supplementary Uplink (SUL) typically operating in a lower frequency band in addition the conventional (non-SUL) carrier so that higher uplink data rates can be provided in power-limited scenarios. A UE in Radio Resource Control (RRC) connected or idle modes may access the NW either through SUL or the conventional (non-SUL) carrier based on network (NW) configuration and certain quality (e.g., pathloss) conditions.

### Network Energy Consumption/Saving

Energy consumption is a major challenge of the 5G system today. Most of the energy consumption comes from Radio Units (RUs) of the RAN. The network energy consumption is said to be less for NR compared to Long Term Evolution (LTE) because of the lean NR design. In the current implementation, however, NR will most likely consume more energy compared to LTE, e.g., due to denser network deployment, larger number of antennas, larger bandwidths, more carriers, and other new (performance-enhancing) features that cause additional energy consumption.

Moreover, today's RAN is typically deployed in a layered fashion. The RAN capabilities are enhanced by adding carriers or spectrum to macro sites and deploying micro and indoor sites to complement the macro layers to boost coverage (e.g., indoor coverage), absorb traffic, and improve user experience, especially during peak traffic hours. These RAN deployments will, however, lead to excess network capacity at times of low demand (i.e.,. low traffic), which will thus result in unnecessarily high energy consumption if not counteracted with suitable energy saving techniques.

Cell deactivation is a conventional energy saving technique in the spatial domain that takes advantage of the opportunity to offload UEs and thus the associated traffic in a layered RAN structure with overlapping coverage areas to reduce the RAN energy consumption. However, cell deactivation comes at the price of long cell reactivation delays in case the additional network capacity is needed to provide a certain user experience or opportune for other reasons, which significantly limits the opportunities or amount of time for employing this energy saving technique.

More granular energy saving techniques in time, frequency, spatial, and power domains are foreseen. An example for UE energy saving techniques in the time domain is Discontinuous Reception (DRX). Like LTE, NR comprises techniques supporting DRX for the UE to reduce the UE energy consumption. DRX can be used in both RRC Connected mode (C-DRX) and RRC Idle and Inactive mode (DRX). It resembles an agreement between network and UE that, regardless of downlink traffic, the network will only attempt to contact the UE during on-times of the configured DRX cycle/pattern. Thus, the UE must monitor/decode the downlink channels only as configured and can otherwise sleep (i.e., be in a low power/energy state) (i.e., sleep during off-times). In case of uplink traffic, however, the UE may initiate transmission regardless of the DRX configuration. Simply put, the gNB must be prepared to receive uplink traffic at any time.

DRX, or generally Discontinuous Transmission and Reception (DTRX) for the network is a promising approach enabling the network to introduce certain off-times in which transmission and/or reception is suspended/interrupted, and an RU, or at least a part/element/component thereof, is put in a low power/energy state. In other words, DTRX enables the network to operate on a certain duty cycle by which the available network capacity is scaled accordingly (up or down). In such a way, the available network capacity can dynamically be adjusted to the required network capacity, always as per current traffic demand, but without having to offload UEs to neighboring cells with overlapping coverage areas, i.e., UEs can stay connected to a cell employing DTRX, and considerably smaller transition times and lower signaling overhead between NG-RAN nodes on the Xn interface. Furthermore, as described in U.S. Provisional patent application no. 63/396,115, methods were developed for various network nodes (e.g., RAN nodes such as gNB, gNB-CU, or gNB-DU, or CN nodes, or functions hosted therein, such as AMF) to coordinate and exchange information associated to at least a DTRX pattern employed, or to be employed, at one or more network nodes.

### SUMMARY

Certain challenges presently exist. For instance, while DTRX for the network is a promising, flexible method for network energy saving, it comes with a considerable impact on traffic and access latency. The longer the off-period duration of the NW DTRX scheme, the longer time it may take for a UE to access the NW (e.g., the UE will need to keep data in its transmit buffer for longer). Such delay may not always be tolerated by the UE, especially for certain delay-sensitive types of UEs or applications. This may result in that the NW does not take the risk for configuring long off-periods and instead sacrifice low energy consumption for the sake of latency.

Certain aspects of the disclosure and their embodiments provide solutions to these or other challenges. For example, disclosed herein are methods and devices that enable one or more network nodes (e.g., RAN nodes such as gNB, gNB-CU, or gNB-DU, or CN nodes, or functions hosted therein, such as AMF) or resources within the one or more network nodes (e.g. SUL carrier or SCell UL resources within the same node or UL resources such as Random Access/PUCCH on another node) to operate such that while one or more node/resource is in DTRX off-period, there are other nodes/resources available for certain UEs/services for accessing the NW. In some embodiments, the DTRX configurations between nodes/resources are coordinated (e.g., misaligned) such that there are more opportunities for the UE to access the NW. In some embodiments, the UEs are configured and/or informed about such “backup” resources and their associated DTRX patterns. As a result, the UEs can reduce unnecessary access delay in case the normal/conventional UL resources are not available while the NW is in off-period of the DTRX, instead the UL access is performed via the backup resources.

When Dual Connectivity (DC) is being set up, the master node (MN) may use the above information to select the best secondary node (SN). Further, for ultra-reliable, low-latency (URLLC) services, Packet Data Convergence Protocol (PDCP) duplication (up to 4 radio link control (RLC) entities with the current specification) can be configured for the certain Data Radio Bearer (DRB). The node hosting the PDCP entity can use the knowledge of how the master cell group (MCG) or secondary cell group (SCG) cells are configured with DTRX to: (1) Determine how the PDCP duplication is setup; (2) may switch between the split bearer and PDCP duplication; and/or (3) control activation and/or deactivation of UL PDCP duplication. With the dynamic Media Access Control (MAC) CE control, PDCP entity may communicate the DTRX scheme for the cells to the RLC and/or MAC entity to control the UL PDCP duplication.

Accordingly, in one aspect there is provided a method performed by UE for reducing latency. The method includes receiving first configuration information for at least a first uplink (UL) resource, the first UL resource used to access a wireless network and associated with a network node operating in discontinuous transmission and reception (DTRX). The method also includes receiving second configuration information for at least a second UL resource, the second UL resource also used to access the wireless network. The method further includes accessing the wireless network using the second UL resource when the first UL resource is in an off period of the DTRX.

In another aspect there is provided a method performed by a network node for reducing latency. The method includes determining at least a second UL resource to be at least partially available while a first UL resource is in an off-period of a first DTRX scheme. The method also includes transmitting to a UE second configuration information for the second UL resource. The method also includes receiving a message from the UE via the second UL resource during a period of time in which the first UL resource is in an off-period of the first DTRX scheme.

In another aspect there is provided a computer program comprising instructions which when executed by processing circuitry of a UE causes the UE to perform any of the UE methods disclosed herein. In another aspect there is provided a computer program comprising instructions which when executed by processing circuitry of a network node causes the network node to perform any of the network node methods disclosed herein. In one embodiment, there is provided a carrier containing the computer programs wherein the carrier is one of an electronic signal, an optical signal, a radio signal, and a computer readable storage medium.

In another aspect there is provided UE that is configured to perform the UE methods disclosed herein. The UE may include memory and processing circuitry coupled to the memory. Similarly, in another aspect there is provided network node that is configured to perform the network node methods disclosed herein. The network node may include memory and processing circuitry coupled to the memory.

An advantage of the embodiments disclosed herein is that they shorten the UL access latency for a UE because there are more opportunities for UL access compared to conventional schemes due to the coordination of off-periods, while at the same time the NW nodes or resources of same node can each operate with longer DTRX scheme and save energy.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 illustrates separation of gNB-CU-CP and gNB-CU-UP.

FIG. 3 illustrates an operation of DTRX.

FIG. 4 illustrates that a DTRX scheme can have different on-period allocations for DL and UL respectively.

FIG. 5 illustrates a coordination of two DTRX timelines according to an embodiment.

FIG. 6 illustrates that a backup node need not necessarily operate in DTRX.

FIG. 7 illustrates a coordination of two DTRX timelines according to an embodiment.

FIG. 8 illustrates a coordination of two DTRX timelines according to an embodiment.

FIG. 9 is a flowchart illustrating a process according to an embodiment.

FIG. 10 shows an example of a communication system in accordance with some embodiments.

FIG. 11 shows a UE in accordance with some embodiments.

FIG. 12 shows a network node in accordance with some embodiments.

FIG. 13 shows a host in accordance with some embodiments.

FIG. 14 is a block diagram illustrating a virtualization environment in which functions implemented by some embodiments may be virtualized.

FIG. 15 shows a communication diagram of a host communicating via a network node with a UE over a partially wireless connection in accordance with some embodiments.

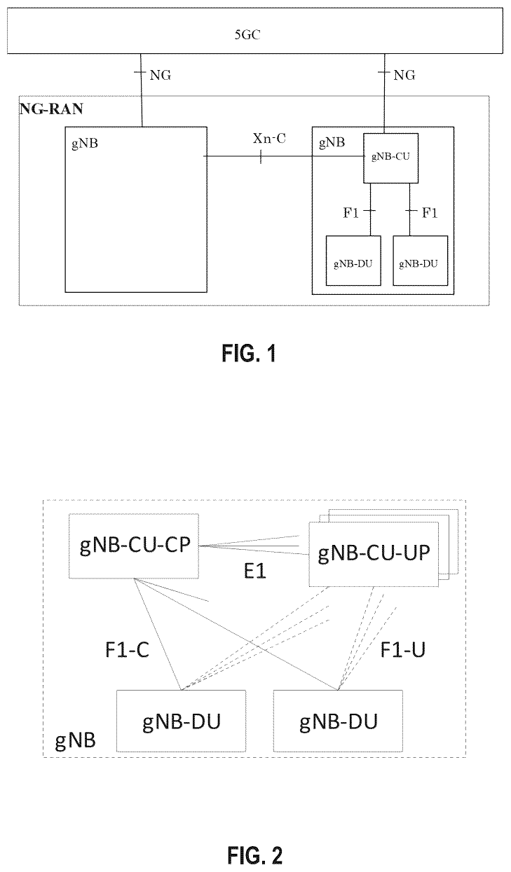

### DETAILED DESCRIPTION

Some of the embodiments contemplated herein will now be described more fully with reference to the accompanying drawings. Embodiments are provided by way of example to convey the scope of the subject matter to those skilled in the art.

Certain embodiments comprise a method executed by a first network node in a communication network with a first set of resources operating in DTRX. The method may include configuring at least a second set of UL resources (e.g., PRACH, PUCCH, PUSCH, PWUS) potentially operating with a second DTRX scheme on the same node (e.g., SCell resources, SUL resources, WUS resources), where the second set of resources can be used for potential UE access fully or partially being available while the first set of resources are in off-period of the first DTRX scheme. The method includes negotiating/coordinating with at least a second network node (e.g., geographically overlapping coverage node) with respect to at least a second set of UL resource (e.g., PRACH, PUCCH, PUSCH, PWUS) on the second node such that potential off-periods of the resources on first and second node are not fully aligned. The method may include providing configuration to the UEs describing which UL resources are permitted to be used in case the first set of resources are in off-period of the DTRX. In some embodiments, the configuration further describes whether the one or more of second set of resources are allowed to be used by all UEs, or only some types of UEs (e.g., URLLC type of UEs), or for certain applications/bearers (e.g., emergency services, Voice, etc.) used by the UEs. This may involve neighboring nodes exchanging service support capabilities, such as support of emergency fallback services, so that the right type of resources are included. In some embodiments, the configuration for the second set of resources can dynamically change, including permission for accessing the said set of resources (e.g., temporary barring of resources).

Some embodiments comprise a method executed by a UE in a communication network. The method may comprise receiving configuration for a first set of resources operating in DTRX. The method may also include receiving configuration for at least an additional set of UL resources on a first or a second node for potential access which are to be used while the first set of resources are operating in DTRX and are in off-period. In some embodiments, if allowed (if resources are not barred, if UE is allowed to use the resources according to said configuration), the method may include accessing the NW through the second set of resources while the first set of resources are currently unavailable due to being in off-period of the NW DTRX. In some embodiments, the method may include specifying which layer is in control when different layers within the UE have conflicting commands in transmission.

In some embodiments involving a NG-RAN node split architecture, the communication between the gNB-CU and gNB-DU may be defined. For example, when the set of the resource information are originated from gNB-DU, it is transferred to gNB-CU, before the information is communicated to other NG-RAN node. As another example, the gNB-CU may transfer the resource information to gNB-DU after the negotiation potentially including capability exchange (e.g., support for emergency service, or alike).

In embodiments using Dual Connectivity, communication between a PDCP entity and a RLC/MAC entity may be defined such that the RLC/MAC entity receives MCG/SCG cells DTRX configuration in order to control the UL PDCP duplication activation and/or deactivation.

A “network node” or (“node” for short) can be a RAN node, a Core Network (CN) node, an OAM, an SMO, a Network Management System (NMS), a Non-Real Time RAN Intelligent Controller (Non-RT RIC), a Real-Time RAN Intelligent Controller (RT-RIC), a radio unit (RU) (e.g., a transceiver), a CU, a DU, an antenna system, a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, Open RAN (O-RAN) CU (O-CU), O-CU control plane (CP), O-CU user plane (UP), O-RAN DU (O-DU), O-RAN RU (O-RU), O-RAN eNB (O-eNB), and/or O-RAN gNB (O-gNB).

The term “DTRX” may refer to Discontinuous Transmission and/or Discontinuous Reception, or another Network Energy saving strategy. Furthermore, the terms “DTX” and “DRX”may refer to Discontinuous Transmission and Discontinuous Reception, respectively.

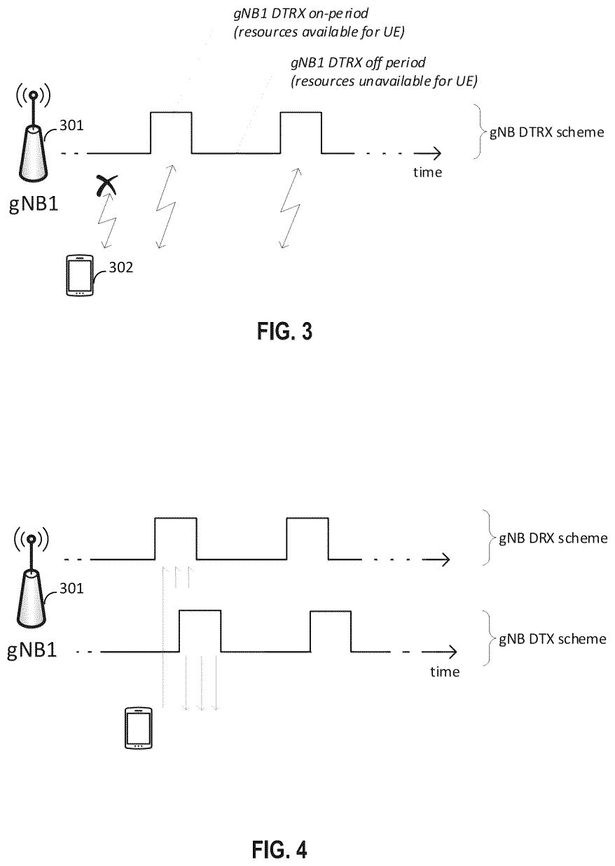

The operation of DTRX is visualized in FIG. 3 where downlink (DL) and/or uplink (UL) resources provided to at least one UE 302 by a first network node 301 (e.g., a gNB or component of a gNB) are only available during the on-periods which may also be referred to as on-durations, and conversely the corresponding off-periods may alternatively be referred to as off-durations.

It shall be noted that in one aspect, the DTRX scheme can have separate timelines and different on-period allocations for DL and UL respectively. This is visualized in FIG. 4 where UL resources 401(e.g., PUCCH, PUSCH, PRACH) can be used by the UE during DRX on-periods, whereas DL 402 resources are available to the UE during the on-periods.

As can be understood, any UL traffic from UE 302 during the off-period will suffer from a delay until UL resources are available; the longer the DTRX cycle (which would be more energy efficient for the NW), the longer the UL access delay for the UE. Such delay may not be tolerable for certain type of UEs (e.g., URLLC) or applications running in the UE (e.g., an emergency call).

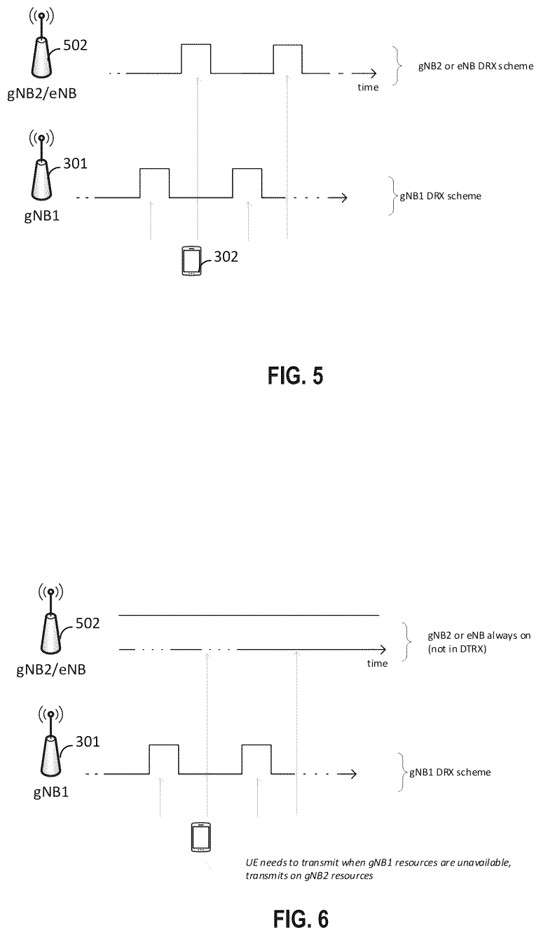

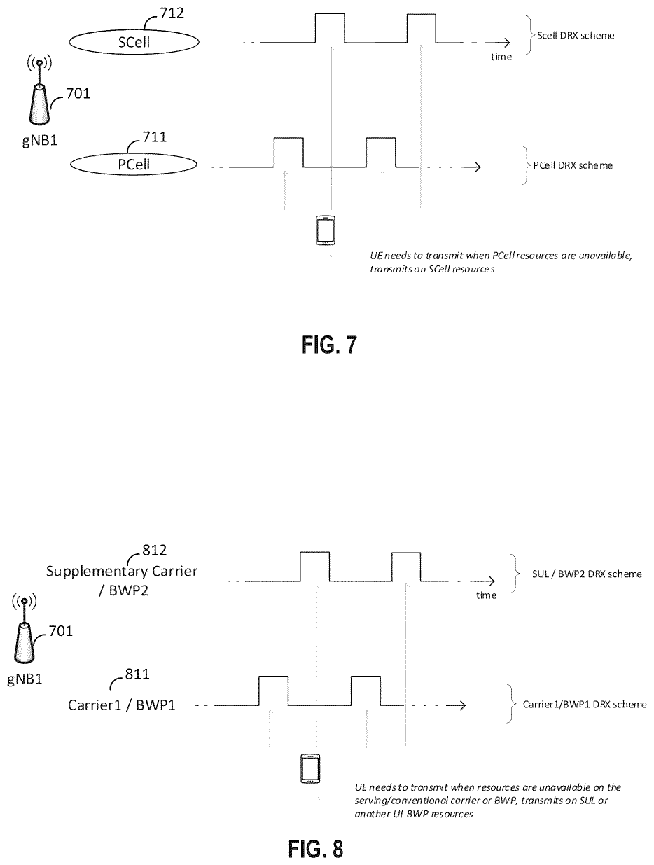

Therefore, to avoid such excessive delay, first network node 301 may exchange DTRX configurations and coordinate the DTRX timelines (planned/scheduled) with a second network node 502 (see FIG. 5) such that the off-periods of the two nodes DTRX are not always aligned. In addition, the configurations for resources are also exchanged and the nodes inform each other that the UEs from one node may access through the resources of the other node acting as a “backup” or proxy node/resource. Furthermore, the UEs served by first node 301 are informed about (configured with) the resources and availability of second node 502. These resources of the second node are to be used by the UE as backup resources in case there is need for immediate access while the first node is in off-period. This is exemplified in FIG. 5. While FIG. 5 shows that first node 301 is a first RAN node (e.g., gNB) and second node 502 is a second RAN node, in other embodiments first node 301 is a first component of a RAN node and second node 502 is a second component of the same RAN node (this is illustrated in FIG. 7 and FIG. 8).

When the second node receives UL signaling from the UE, it may forward it to the first node, or activate the first node (i.e., terminate the first node's DTRX off-period) for further UL signaling reception or DL transmission, etc. For example, in the case of forwarding, the nodes could operate in such manner that second node 502 (a.k.a., the “backup node”) acts as a secondary node in a split-bearer architecture and the UL data is forwarded from the backup node to a PDCP entity in first node 301 (a.k.a., the “main node”). Typically, when legacy bearer split is configured for uplink, UEs are only allowed to use the backup node when there is more UL data than a certain threshold. It is proposed herein that if data forwarding is used, the UE is allowed to access the backup node regardless of the threshold if the main node is currently in off-period. Other examples of data forwarding are of course also possible, such as data forwarding through the Xn interfaces between the gNBs which is typically otherwise used during handover.

It shall be noted that the backup node is not necessarily operating in DTRX. The main and backup nodes, however, shall still be aligned such that the backup node is available while the first node is in off-period. This scenario is illustrated in FIG. 6.

As noted above, it may be the case that the first node and the second node are different components of the same node 701 (e.g., RAN node as shown in FIG. 7). Accordingly, in one aspect, the same node 701 employs a first DTRX cycle for a first resource (e.g., a first radio unit providing service in a first cell 711 (e.g., a primary cell (PCell))) and employs a different, second DTRX cycle for a second resource (e.g., a second radio unit providing service in a second cell 712 (e.g., a secondary cell (SCell))), but the DTRX cycles are coordinated so that, as an example, at any given point in time at least one of the resources 711, 712 is available to receive UL data from UE 302. For example, the very same node 701 (e.g., gNB) may be hosting multiple cells in case of carrier aggregation, configure different DTRX patterns for these cells, provide unaligned off-periods for the cells, and configure the UE with access configuration for the Scell 712 during off-periods of PCell 711. This embodiment is illustrated in FIG. 7. In yet another example, the node 701 may similar as above, configure different DTRX patterns for the ordinary carrier 811 (non-SUL) and the SUL carrier 812, as illustrated in FIG. 8.

Note that the schemes shown in FIGS. 7 and 8 are still energy efficient for node 701 as long as, for example, different radio units (RUs) are involved in the TRX handling for the different resources. The reason being that the RUs are the parts that contribute most to the energy consumption.

In some embodiments, the DTRX cycles may be configured so as to ensure that at least one resource (e.g., call, carrier) is available for an UL transmission for a UE at any given time, minimizing the access latency. In other embodiments, the aggregate of DTRX cycle on-durations may not result in constant UL availability but the delay at any point in time to the beginning of an on-duration of some cell is lower than the tolerable traffic latency in time-critical use cases.

The NW provides configurations for the UEs about when/how to access the backup resources (e.g. SCell 702 or SUL carrier 802). For example, in current NR specifications, a UE's initial access from RRC Idle state may be carried out using either the SUL UL carrier or the non-SUL UL carrier. The separate RACH configurations for these resources are configured in broadcast system information of the cell. The UE then, based on measured RSRP in comparison to a NW configured threshold, performs access on one or the other resource (either SU or non-SUL). Here, additionally temporal conditions are introduced such that the access though SUL may be performed despite good non-SUL RSRP in case the non-SUL carrier is in off-period of its DTRX.

The configurations for UE's way of accessing the backup resources mentioned above, may be provided through either broadcast or dedicated messages. In the broadcast mode, the DTRX configuration info for the first and second (alternative) cells, as well as rules for when to use the second cells may be included in a SIB, e.g. SIB1 or a dedicated energy-saving SIB. In the dedicated mode, the info may be provided to individual UEs via dedicated RRC signaling. The info regarding second (backup) cell RA configuration may be included in the DTRX configuration signaling by the first cell, or it may be obtained by the UE from the second cell SI.

In some embodiments, only certain UEs may be allowed to perform access through backup resources. In some aspect, said access may only be performed for specific services (e.g., identified through 5QI, DRB, or alike). Alternatively, all UEs may use the backup resources when they are configured and signaled via SI.

In some embodiments, a main node (e.g., node 301) may exchange capability/resources availability/load/etc information with one or more backup nodes (e.g., node 502). For example, with respect to various services, e.g., whether the potential backup node is capable of a certain service such as emergency services. Based on such information the main node may choose which nodes that may act as backup nodes. Furthermore, in related embodiments, the UEs may be informed about potential capability/limitation of various backup nodes. For example, if the UE node knows that the backup node is not capable of an emergency service, the UE may for setting up an emergency call then not waste UL resources unnecessarily on the backup node.

In some embodiments, the gNB DTRX configuration provided to UEs by the first node may depend on the traffic type, QoS, QoE, etc. requirements of the UEs in the cell. The first node may for example configure the UEs with second cell info for rapid UL access only if one or more UEs in the cell have low latency requirements, e.g. involved in URLLC or cMTC applications. As described above, such UEs may then be individually configured to access the UL via the second cell, e.g. via dedicated RRC signaling, or all UEs in the first cell may be provided such configuration, e.g. via broadcast signaling (e.g., broadcast System Information (SI)).

In some embodiments, the NW may temporarily inhibit such access for its UEs without having to unconfigure all related parameters. This may for example be useful in case the extra resources are temporarily suffering from high loads. Therefore, similar to the NR EAB (Extended Access Barring) or the like, an access barring configuration is provided via broadcast channels which are applicable to the backup resources. UEs, that possess configuration for and are otherwise allowed to use the backup resources, will not be allowed to use them in case the backup resources access barring configuration disallows it.

In some embodiments, the UE may be configured with a wake-up signal (WUS) procedure in the UL direction such that the UE can transmit a WUS to a gNB to wake-up the gNB receiver (i.e., to cause the gNB to, at the least, immediately transition from off period of DRX cycle to an on state). For example, a URLLC UE can be configured to send an indication to a gNB (e.g., send the indication over an UL channel) indicating that the UE wants to start operating, or that the indication itself is the start of operation and as such the gNB stops DTRX or part of DTRX, e.g., DRX or DTX operations and stays ON in DL or UL until further indication from the URLLC UE or for a certain period.

In this case, the UE can be configured with WUS resources over the same cell, or another cell on the same node or a neighboring node. For example, the WUS may be sent to the main node, in another embodiment, the WUS is sent to the backup node, which in turn wakes up the main node. The NW can decide whether or not to configure a UE with a WUS procedure based on different factors, e.g., based on the traffic type and the UE capability.

For example, the NW may decide to configure a UE with a WUS procedure if the UE has traffic with high QoE/QoS requirements and/or if the UE has limited capabilities in terms of the carriers that it can use. The WUS can be additionally accompanied with a minimum delay between WUS transmission and the UE being able to transmit a UL signal (e.g., PRACH to gNB). The minimum delay is necessary for gNB to leave the off period of its DRX cycle. The minimum delay can be based on pre-configuration or can be provided to the UE as part of WUS configuration. The minimum delay can enable the gNB to employ a low power WUR in other to receive WUS and then the low power WUR is responsible to wake up the main gNB receiver. As such the UE receives a WUS configuration from the gNB or another gNB (e.g., the neighboring gNB), and if the gNB is in off period of DRX cycle, then the UE can transmit a WUS based on the provided configuration, e.g., if the UE has some data to UL, and after waiting for potentially a minimum delay, the UE can start transmitting over the regular UL resources to the gNB. The WUS mechanism in this case can be optionally accompanied with a WUS ACK from the gNB.

In the mechanisms above, the associated configurations, e.g., the second set UL resources as well as other underlying configurations, can be provided to the UE through higher layer signaling (e.g., RRC signaling or SIBs) either through its own serving node, or a neighboring node. The configuration exchange among nodes can be done through existing interfaces.

### Scenarios and Coverage Considerations

It is proposed herein to apply and coordinate DTRX patterns with several NW nodes (e.g. gNBs) covering the same general area, where the nodes may not be co-sited and thus the second cell coverage may not be equal to the first cell coverage, and to multiple cells provided by the same NW node in a co-sited manner. These scenarios may differ in terms of their coverage implications and may require different DTRX coordination logic.

If the switching of currently active cells is to be symmetric coverage-wise, this scheme presumes a deployment type with two quite exactly overlapping cells so that coverage is not changed as they are toggled. Such a NW deployment may be motivated e.g. in order to provide additional capacity at peak times but a more energy-efficient, single-layer operation at off-peak times. The DTRX configuration may then be adapted to whether the second cell(s) are active at a certain point in time.

In other scenarios, unchanging coverage may be of secondary importance and the coordinated cells'(first and second cells) coverage need not be identical. This may be the case for a best-effort private NW installation, e.g. in an office building, where the presence of an underlying and cooperating operator NWs is assumed. The UE may then be configured to use the second cell only when coverage exists, and wait out the first cell's off-period otherwise before attempting UL access.

### UE Procedures

In one embodiment, the UE configured with gNB DTRX operation according to the embodiments disclosed herein will act as if it is connected to, or camping on, alternate cells at different times. The UE may have the first cell as the permanent serving cell. The UE obtains SI from the first cell and uses a RACH configuration for that cell when the first cell is in DTRX on-period, which may be seen as baseline operation. Additionally, the UE obtains info about at least one second cell, e.g. cell ID, that may be used as backup UL access resource. Such info may be obtained from gNB DTRX configuration signaling (dedicated or broadcast) as described above. It may also determine best SSB info and/or receive SI from the second cell, including RACH configuration info, ahead of the DTRX off-period of the first cell. This allows the UE to utilize the second cell's UL resources with minimum latency and/or energy consumption.

Alternatively, the UE may follow the conventional RACH-based access procedure towards the second cell when the need for UL access arises during first cell off-period. This includes searching for SSBs associated with the second cell ID, determining the best SSB and reading the SI, and performing RA according to the RA configuration.

In some embodiments, the gNB DTRX configuration may indicate that multiple second cells may be available during some first cell off-periods. The UE may then previously evaluate the link quality of the multiple second cells and use the cell with best quality if UL access is required during first cell off-period.

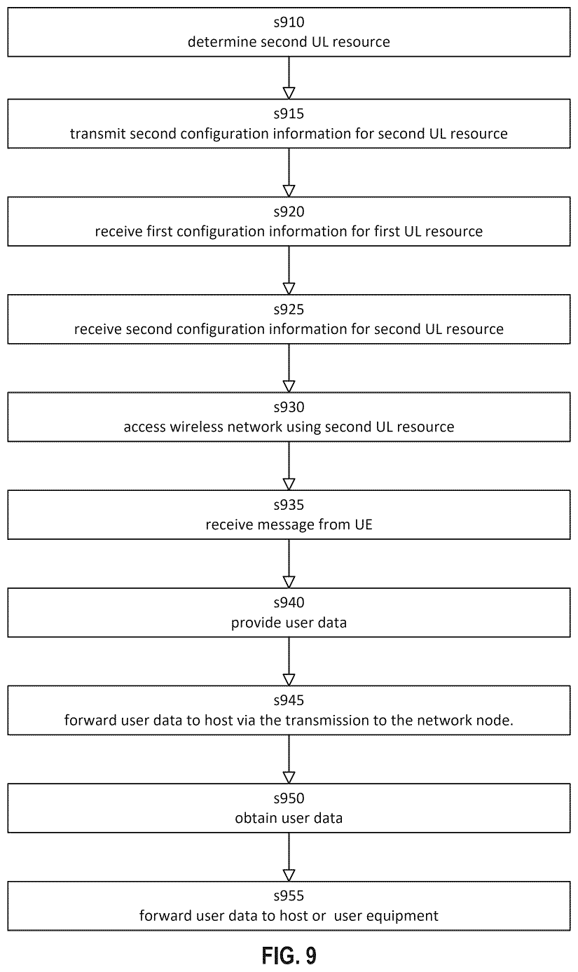

FIG. 9 depicts a method in accordance with particular embodiments. For purposes of simplifying the discussion, the steps performed by a user equipment and a network node have been combined in the above flow chart. Thus, neither a user equipment nor a network node will perform all the steps of FIG. 9.

As depicted, the method begins at step s910 where a network node (NN) (e.g., node 301, 502, or 701) determines a second UL resource. This resource is to be made available at least partially during off-periods of a first UL resource so that the UE, if allowed, can access the wireless network if the first UL resource is in an off period (or at least reduce the delay before the UE can access the network). This may involve negotiating or coordinating with one or more neighbor cells or network nodes. These neighbors may have at least partially overlapping coverage areas.

At step s915 the NN transmits second configuration information for the second UL resource. The second configuration information may comprise configuration information for a plurality of potential UL resources that can be used as the second UL resource. The second configuration information may be broadcasted or signaled directly to the UE.

At step s920 the UE receives first configuration information for a first UL resource. This step may be performed before step s910, concurrently with step s925 (e.g., in the same message) or after step s925.

At step s925 the UE receives the second configuration information for the second UL resource. The first and second UL resources may be associated with the same network node or different network nodes.

At step s930 the UE accesses the wireless network using the second UL resource, and, at step s935, the NN receives a message from the UE via the second UL resource. The UE may first check the configuration information and/or one or more parameters (e.g., reference signal strength) to determine if it is allowed to the access the wireless network using the second UL resource at the current time. The message may be a wake-up message. The wake-up message may be to wake up either UL resource. In some scenarios, the message may be forward from the NN to another NN.

At step s940, the UE provides user data (e.g., a request for data based on user input). At step s945 the UE forwards the user data to a host computer via the NN. At step s950 the NN obtains the user data. At step s955 the NN then forwards the user data to the host computer. User data can also flow in the opposite direction in which the NN obtains user data and then forwards the data to the UE.

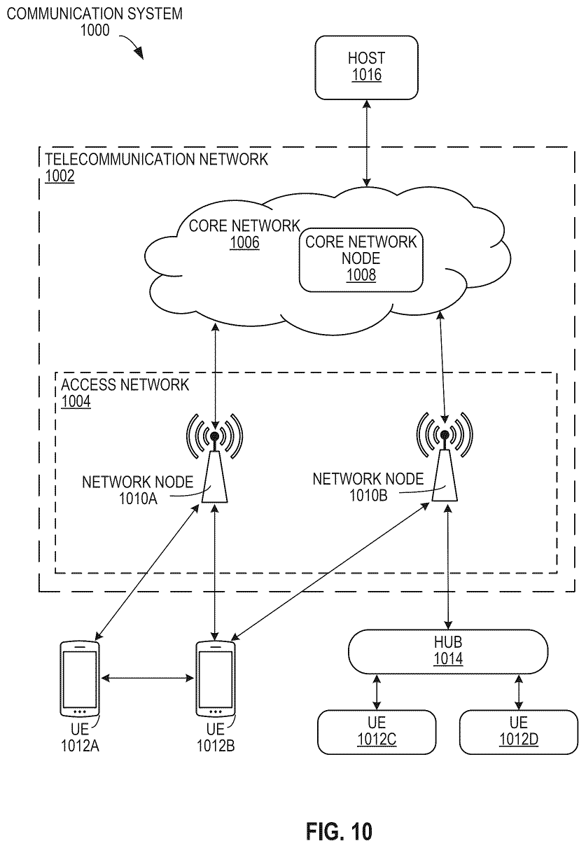

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

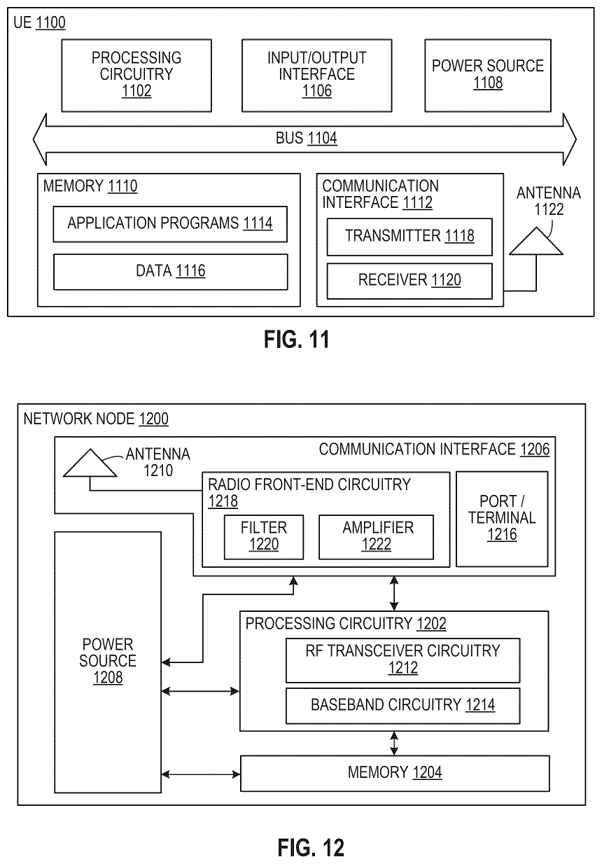

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

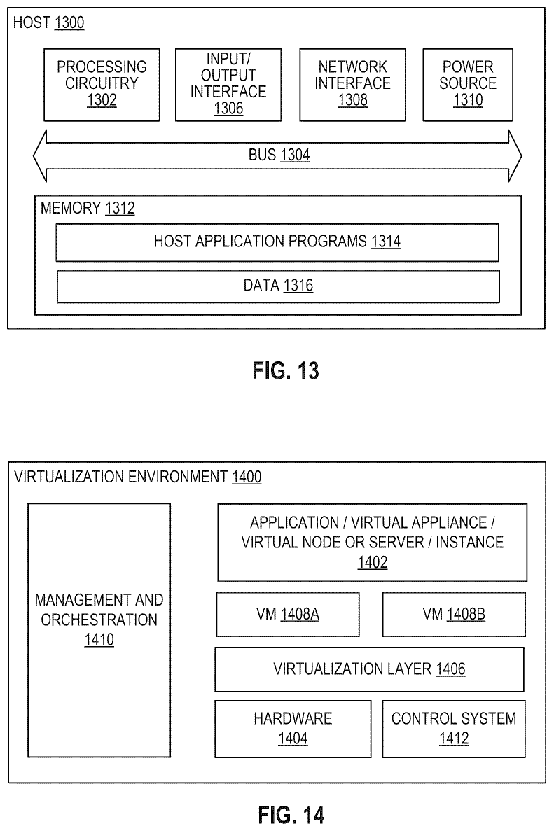

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

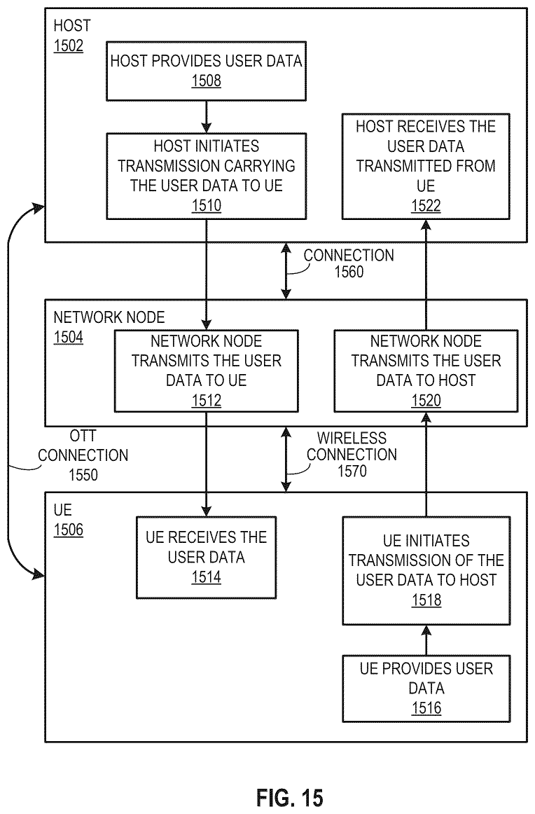

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve the energy efficiency of the wireless network with minimal impact to latency for the UEs. This may provide benefits such as decreased energy consumption, improved latency times when trying to initially reach a network node that may be in a sleep or reduced power cycle.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc. ; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Summary of Various Embodiments

### Group A Embodiments

1. A method performed by a user equipment (UE) for reducing latency during network discontinuous transmission and reception (DTRX), the method comprising: receiving first configuration information for at least a first uplink (UL) resource, the first UL resource used to access a wireless network and associated with a network node operating in DTRX; receiving second configuration information for at least a second UL resource, the second UL resource also used to access the wireless network; and accessing the wireless network using the second UL resource when the first UL resource is in an off period of the DTRX.
2. The method of 1 wherein the first and second UL resource are associated with the same network node or with different network nodes.
3. The method of 1 or 2 wherein the first and second configuration information is received in the same message or is received in different messages.
4. The method of any of 1-3 wherein the first or second configuration information further comprising an indication that the second UL resource is to be used while the first UL resource is operating in DTRX and is in an off-period.
5. The method of any of 1-4 further comprising determining if the UE is allowed to access the wireless network using the second UL resource.
6. The method of 5 wherein determining if the UE is allowed to access the wireless network using the second UL resource comprises determining one or more of the following: whether or not the UE is barred from using the second UL resource; whether or not one or more conditions are present or absent such that UE is allowed to use the resources according to one or more parameters in the first or second configuration information.
7. The method of any of 1-6 wherein the first or second configuration information comprises an indication of how to resolve a conflict between different layers within the UE having conflicting commands. 8. The method of any of 1-7 wherein the second UL resource comprises at least one of a PRACH resource, a PUCCH resource, PUSCH resource, or PWUS resource.
9. The method of any of 1-8 wherein the second UL resource is at least available during at least a portion of the down time of the first UL resource.
10. The method of any of 1-9 wherein the first or second configuration information comprises an indication if the second UL resource is available for all UEs, for specific UE, for UEs of one or more specific types, for all applications and/or bearers, and/or for one or more specific applications and/or bearers.
11. The method of any of 1-10 further comprising measuring one or more reference signals, wherein the UE access the wireless using the second UL resource upon the reference signal exceeding a threshold or upon the reference signal being below a threshold.
12. The method of any of 1-11 wherein the configuration information comprises information for a wake-up signal; and the method further comprises transmitting the WUS via the second UL resource when the first UL resource is in a down period.
13. The method of any of 1-12 wherein the second configuration information comprises information for a plurality of different UL resources, the method further includes determining which UL resource to use as the second UL resource.
14. The method of 13 wherein the determination of which UL resource to use as the second UL resources is based on signal strength, and/or UL resourced availability.
15. The method of any of the previous embodiments, further comprising: providing user data; and forwarding the user data to a host via the transmission to the network node.

### Group B Embodiments

16. A method performed by a network node for reducing latency during network discontinuous transmission and reception (DTRX), the method comprising: determining at least a second UL resource to be at least partially available while a first UL resource is in an off-period of a first DTRX scheme; transmitting to a UE second configuration information for the second UL resource; receiving a message from the UE via the second UL resource during a period of time in which the first UL resource is in an off-period of the first DTRX scheme.
17. The method of 16 wherein the first and second UL resource are associated with the same network node or with different network nodes.
18. The method of 16 or 17 wherein the first and second configuration information is transmitted to the UE in the same message.
19. The method of any of 16-17 wherein the first or second configuration information further comprising an indication that the second UL resource is to be used while the first UL resource is operating in DTRX and is in an off-period.
20. The method of any of 16-19 wherein the configuration information comprises one or more parameters to be used by the UE to determine if it is allowed to access the second UL resource.
21. The method of any of 16-20 wherein the first or second configuration information comprises an indication of how to resolve a conflict between different layers within the UE having conflicting commands. 22. The method of any of 16-21 wherein the second UL resource comprises at least one of a PRACH resource, a PUCCH resource, PUSCH resource, or PWUS resource.
23. The method of any of 16-22 wherein the second UL resource is at least available during at least a portion of the down time of the first UL resource.
24. The method of any of 16-23 wherein the first or second configuration information comprises an indication if the second UL resource is available for all UEs, for specific UE, for UEs of one or more specific types, for all applications and/or bearers, and/or for one or more specific applications and/or bearers.
25. The method of any of 16-24 further comprising negotiating or coordinating with a second network node for the second UL resource so that any on periods and off periods of the first and second UL resources are aligned to reduce the amount of time both resources are off at the same time.
26. The method of 25 wherein negotiating or coordinating comprises exchanging service support capabilities.
27. The method of any of 25-26 wherein negotiating or coordinating comprises exchanging DTRX configurations and timelines such that the off-periods of the two nodes DTRX are not always concurrent.
28. The method of any of 25-27 wherein negotiating or coordinating comprises configuring each cell's DTRX cell such that at least one cell is available for an UL transmission for a UE at any time.
29. The method of any of 16-27 wherein the second configuration information for the second UL resource changes dynamically.
30. The method of any of 16-29 further comprising forwarding the message to the first network node.
31. The method of any of 16-30 wherein the message activates the first or second node.
32. The method of any of 16-31 wherein transmitting to the UE second configuration information for the second UL resource comprises transmitting via broadcast or transmitting via dedicated signaling.
33. The method of any of 16-32 further comprising selecting one or more nodes or cells from among a plurality of nodes or cells to use for the second UL resource.
34. The method of any of 16-33 wherein the second configuration information comprises information about one or more capabilities and/or one or more limitations of the second UL resource.
35. The method of any of 16-34 further comprising transmitting a configuration message temporarily limiting access to the second UL resource.
36. The method of any of 16-35 wherein the second configuration information is provided via higher layer signaling such as RRC signaling or SIBs.
37. The method of any of the previous embodiments, further comprising: obtaining user data; and forwarding the user data to a host or a user equipment.

### Group C Embodiments

38. A user equipment for reducing latency during network discontinuous transmission and reception (DTRX), comprising: processing circuitry configured to perform any of the steps of any of the Group A embodiments; and power supply circuitry configured to supply power to the processing circuitry.
39. A network node for reducing latency during network discontinuous transmission and reception (DTRX), the network node comprising: processing circuitry configured to perform any of the steps of any of the Group B embodiments; power supply circuitry configured to supply power to the processing circuitry.
40. A user equipment (UE) for reducing latency during network discontinuous transmission and reception (DTRX), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
41. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.
42. The host of the previous embodiment, wherein the cellular network further includes a network node configured to communicate with the UE to transmit the user data to the UE from the host.
43. The host of the previous 2 embodiments, wherein: the processing circuitry of the host is configured to execute a host application, thereby providing the user data; and the host application is configured to interact with a client application executing on the UE, the client application being associated with the host application.
44. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.
45. The method of the previous embodiment, further comprising: at the host, executing a host application associated with a client application executing on the UE to receive the user data from the UE.
46. The method of the previous embodiment, further comprising: at the host, transmitting input data to the client application executing on the UE, the input data being provided by executing the host application, wherein the user data is provided by the client application in response to the input data from the host application.
47. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
48. The host of the previous embodiment, wherein the cellular network further includes a network node configured to communicate with the UE to transmit the user data from the UE to the host.
49. The host of the previous 2 embodiments, wherein: the processing circuitry of the host is configured to execute a host application, thereby providing the user data; and the host application is configured to interact with a client application executing on the UE, the client application being associated with the host application.
50. A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.
51. The method of the previous embodiment, further comprising: at the host, executing a host application associated with a client application executing on the UE to receive the user data from the UE.
52. The method of the previous embodiment, further comprising: at the host, transmitting input data to the client application executing on the UE, the input data being provided by executing the host application, wherein the user data is provided by the client application in response to the input data from the host application.
53. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
54. The host of the previous embodiment, wherein: the processing circuitry of the host is configured to execute a host application that provides the user data; and the UE comprises processing circuitry configured to execute a client application associated with the host application to receive the transmission of user data from the host.
55. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.
56. The method of the previous embodiment, further comprising, at the network node, transmitting the user data provided by the host for the UE.
57. The method of any of the previous 2 embodiments, wherein the user data is provided at the host by executing a host application that interacts with a client application executing on the UE, the client application being associated with the host application.
58. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
59. The communication system of the previous embodiment, further comprising: the network node; and/or the user equipment.
60. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
61. The host of the previous 2 embodiments, wherein: the processing circuitry of the host is configured to execute a host application, thereby providing the user data; and the host application is configured to interact with a client application executing on the UE, the client application being associated with the host application.
62. The host of the any of the previous 2 embodiments, wherein the initiating receipt of the user data comprises requesting the user data.
63. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.
64. The method of the previous embodiment, further comprising at the network node, transmitting the received user data to the host.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### Abbreviations

At least some of the following abbreviations may be used in this disclosure. If there is an inconsistency between abbreviations, preference should be given to how it is used above. If listed multiple times below, the first listing should be preferred over any subsequent listing(s).
3GPP 3rd Generation Partnership Project
5G 5th Generation
5GC 5G Core network
5GS 5th Generation System
AMF Access and Mobility Management Function
ARQ Automatic Repeat Request
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CN Core Network
CP Control Plane
CPICHCommon Pilot Channel
CQI Channel Quality information
C-RNTI Cell RNTI
CSI Channel State Information
CU Central Unit
CU-CPCentral Unit Control Plane
CU-UP Central Unit User Plane
DC Dual Connectivity
DCCH Dedicated Control Channel
DL Downlink
DMRS Demodulation Reference Signal
DRX Discontinuous Reception
DTX Discontinuous Transmission
DU Distributed Unit
E-CID Enhanced Cell-ID (positioning method)
EN E-UTRAN-NR
eNB Evolved Node B/E-UTRAN Node B
en-gNB A gNB acting as a secondary node in an EN-DC scenario (i.e., in a DC scenario with an eNB as the master node and a gNB as the secondary node.
ePDCCH enhanced Physical Downlink Control Channel
E-UTRA Evolved UTRA
E-UTRAN Evolved UTRAN
FDD Frequency Division Duplex
FFS For Further Study
gNB Base station in NR
GNSS Global Navigation Satellite System
GSM Global System for Mobile communication
HARQ Hybrid Automatic Repeat Request
HO Handover
HSPA High Speed Packet Access
IAB Integrated Access and Backhaul
IE Information Element
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MIB Master Information Block
MME Mobility Management Entity
MSC Mobile Switching Center
NES Network Energy Saving
NG Next Generation
NG The interface between an NG-RAN and a 5GC.
NGAP NG Application Protocol
NG-RAN NG Radio Access Network
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
OAM Operation, Administration and Maintenance
PBCH Physical Broadcast Channel
P-CCPCH Primary Common Control Physical Channel
PCell Primary Cell
PDCCH Physical Downlink Control Channel
PDCP Packet Data Convergence Protocol
PDSCH Physical Downlink Shared Channel
PGW Packet Gateway
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
QoE Quality of Experience
RACH Random Access Channel
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
S1 The interface between the RAN and the CN in LTE.
S1AP S1 Application Protocol
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SMO Service Management and Orchestration
SNR Signal to Noise Ratio
SON Self Optimized Network
SS Synchronization Signal
SSS Secondary Synchronization Signal
TDD Time Division Duplex
TSS Tertiary Synchronization Signal
TTI Transmission Time Interval
UE User Equipment
UL Uplink
UMTS Universal Mobile Telecommunication System
USIM Universal Subscriber Identity Module
UTRA Universal Terrestrial Radio Access
UTRAN Universal Terrestrial Radio Access Network
WCDMA Wide CDMA
WLANWide Local Area Network
WUS Wake Up Signal
Xn The interface between two gNBs in NR.
XnAP Xn Application Protocol

1. A method performed by a user equipment, UE, for reducing latency, the method comprising:
receiving first configuration information for at least a first uplink, UL, resource, the first UL resource used to access a wireless network and associated with a network node operating in discontinuous transmission and reception, DTRX;
receiving second configuration information for at least a second UL resource, the second UL resource also used to access the wireless network; and
accessing the wireless network using the second UL resource when the first UL resource is in an off period of the DTRX.

2.-3. (canceled)

4. The method of claim 1, wherein the first or second configuration information further comprises an indication that the second UL resource is to be used while the first UL resource is operating in DTRX and is in an off-period.

5. The method of claim 1, further comprising determining whether the UE is allowed to access the wireless network using the second UL resource.

6. The method of claim 5, wherein determining whether the UE is allowed to access the wireless network using the second UL resource comprises:
determining whether the UE is barred from using the second UL resource; and/or
determining whether one or more conditions are present or absent such that UE is allowed to use the resources according to one or more parameters in the first or second configuration information.

7. The method of claim 1, wherein the first or second configuration information comprises an indication of how to resolve a conflict between different layers within the UE having conflicting commands.

8. The method of claim 1, wherein the second UL resource comprises: a PRACH resource, a PUCCH resource, a PUSCH resource, and/or a PWUS resource.

9. The method of claim 1, wherein the second UL resource is at least available during at least a portion of the down time of the first UL resource.

10. (canceled)

11. The method of claim 1, further comprising measuring one or more reference signals, wherein the UE accesses the wireless network using the second UL resource upon the reference signal exceeding a threshold or upon the reference signal being below a threshold.

12. The method of claim 1, wherein
the configuration information comprises information for a wake-up signal, WUS, and
the method further comprises transmitting the WUS via the second UL resource when the first UL resource is in a down period.

13. The method of claim 1, wherein
the second configuration information comprises information for a plurality of different UL resources, and
the method further includes determining which UL resource to use as the second UL resource.

14.-15. (canceled)

16. A method performed by a network node for reducing latency, the method comprising:
determining at least a second uplink, UL, resource to be at least partially available while a first UL resource is in an off-period of a first discontinuous transmission and reception, DTRX, scheme;
transmitting to a user equipment, UE, second configuration information for the second UL resource; and
receiving a message from the UE via the second UL resource during a period of time in which the first UL resource is in an off-period of the first DTRX scheme.

17.-18. (canceled)

19. The method of claim 16, wherein the first or second configuration information further comprises an indication that the second UL resource is to be used while the first UL resource is operating in DTRX and is in an off-period.

20. (canceled)

21. The method of claim 16, wherein the first or second configuration information comprises an indication of how to resolve a conflict between different layers within the UE having conflicting commands.

22. (canceled)

23. The method of claim 16, wherein the second UL resource is at least available during at least a portion of the down time of the first UL resource.

24. (canceled)

25. The method of claim 16, further comprising negotiating or coordinating with a second network node for the second UL resource so that any on periods and off periods of the first and second UL resources are aligned to reduce the amount of time both resources are off at the same time.

26. (canceled)

27. The method of claim 25, wherein negotiating or coordinating comprises exchanging DTRX configurations and timelines such that the off-periods of the two nodes DTRX are not always concurrent.

28. The method of claim 25, wherein negotiating or coordinating comprises configuring each cell's DTRX cell such that at least one cell is available for an UL transmission for a UE at a given time.

29.-32. (canceled)

33. The method of claim 16, further comprising selecting one or more nodes or cells from among a plurality of nodes or cells to use for the second UL resource.

34. The method of claim 16, wherein the second configuration information comprises information about one or more capabilities and/or one or more limitations of the second UL resource.

35. The method of claim 16, further comprising transmitting a configuration message temporarily limiting access to the second UL resource.

36.-39. (canceled)

40. A user equipment, UE, configured to perform a method for reducing latency, the method comprising:
receiving first configuration information for at least a first uplink, UL, resource, the first UL resource used to access a wireless network and associated with a network node operating in discontinuous transmission and reception, DTRX;
receiving second configuration information for at least a second UL resource, the second UL resource also used to access the wireless network; and
accessing the wireless network using the second UL resource when the first UL resource is in an off period of the DTRX.

41.-43. (canceled)
